(19) United States
(12) Patent Application Publication
(10) Pub. No.: US 2015/0191039 A1
(43) Pub. Date: Jul. 9, 2015

(54) Adjustable Framing Square

(71) Applicant: Morris Johnson, Decatur, IL (US)

(72) Inventor: Morris Johnson, Decatur, IL (US)

(21) Appl. No.: 14/593,428

(22) Filed: Jan. 9, 2015

Related U.S. Application Data
(60) Provisional application No. 61/925,248, filed on Jan. 9, 2014.

(51) Int. Cl. B43L 7/14; B43L 7/027

(52) U.S. Cl. CPC B43L 7/14; B43L 7/027

(57) ABSTRACT

An adjustable dual framing square is provided. The present system comprises a pair of L-shaped framing square members that are removably attached together via connectors through slots on each of the framing square members. The length of the slots through which the connectors are disposed to secure the members together allow the positon and the orientation of the members to be adjusted relative to each other. The present invention can be utilized to transfer parallel lines, as inside calipers, as outside calipers, to calculate unknown angles, and for a variety of other purposes.

### CROSS REFERENCE TO RELATED APPLICATION

This application claims the benefit of U.S. Provisional Application No. 61/925,248 filed on Jan. 9, 2014. The above identified patent application is herein incorporated by reference in its entirety to provide continuity of disclosure.

### FIELD OF THE INVENTION

The present invention relates to framing squares. More specifically, the present invention relates to framing squares having multiples portions that are removably connected together, allowing users to quickly calculate angles, make straight lines when surrounded by rough edges, and square an object over an obstacle.

### BACKGROUND OF THE INVENTION

Without highly technical tools, it can be difficult for construction workers to determine the size of a round object, administer a square line on a small round object, square a fitting to a sloping object, find an angle when the pitch is unknown, square an object over an obstacle, make a straight line when surrounded by rough edges, and duplicate the same measurement repeatedly. Therefore, many workers guess angles and measurements. Unfortunately, if incorrect, workers have to redo the job, which can be extremely time consuming, wasteful, and expensive.

### SUMMARY OF THE INVENTION

In view of the foregoing disadvantages inherent in the known types of framing squares now present in the prior art, the present invention provides an adjustable framing square wherein the same can be utilized for providing convenience for the user when squaring an object around an obstacle, measuring angles, and performing other such tasks. The present system comprises a pair of L-shaped framing square members that are removably attached together via connectors through slots on each of the framing square members. The length of the slots through which the connectors are disposed to secure the members together allow the positon and the orientation of the members to be adjusted relative to each other.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded view of the present invention.

FIG. 2 shows a view of the present invention in a first arrangement.

FIG. 3 shows a view of the present invention in a second arrangement.

FIG. 4 shows a view of the present invention in a third arrangement.

### DETAILED DESCRIPTION OF THE INVENTION

Reference is made herein to the attached drawings. Like reference numerals are used throughout the drawings to depict like or similar elements of the framing square. For the purposes of presenting a brief and clear description of the present invention, the preferred embodiment will be discussed as used for squaring objects around obstacles and measuring angles. The figures are intended for representative purposes only and should not be considered to be limiting in any respect.

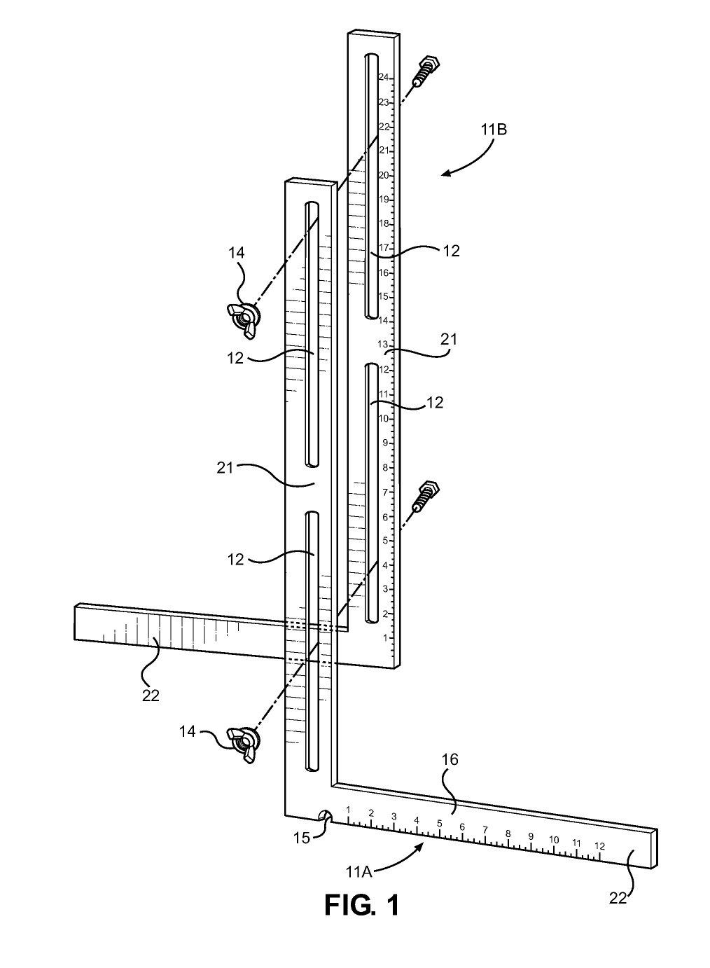

Referring now to FIG. 1, there is shown an exploded view of the present invention. The present invention is a framing square having a first member 11A and a second member 11B removably secured together. Because the members 11A, 11B are removably attached together, users can adjust their positions and orientations relative to each other in order to assist in making complex measurements and framing objects around obstacles. The present invention comprises a first L-shaped member 11A and a second L-shaped member 11B that are removably secured together by one or more connectors 14 through one or more slots 12 disposed along the lengths of the members 11A, 11B. The depicted embodiment of the present invention utilizes two connectors 14; however, no claim is made as to the precise number of connectors 14 utilized to secure the L-shaped members 11A, 11B together. The connectors 14 comprise wing nuts that engage with a fastener or any other such means of removably fastening the members 11A, 11B together.

Each of the members 11A, 11B comprises a first portion 21 and a second portion 22 disposed orthogonally relative to each other. The slots 12 are positioned on the first portions 21 of the members 11A, 11B so that the first portion 11A of the first member 11A can be secured to the complementary first portion 21 of the second member 11B. The members 11A, 11B further comprise numerical indicia 16 disposed their sides. In one embodiment of the present invention, the members 11A, 11B are double-sided with indicia 16. The numeral indicia 16 may be disposed on the first portion 21, the second portion 22, or both portions 21, 22.

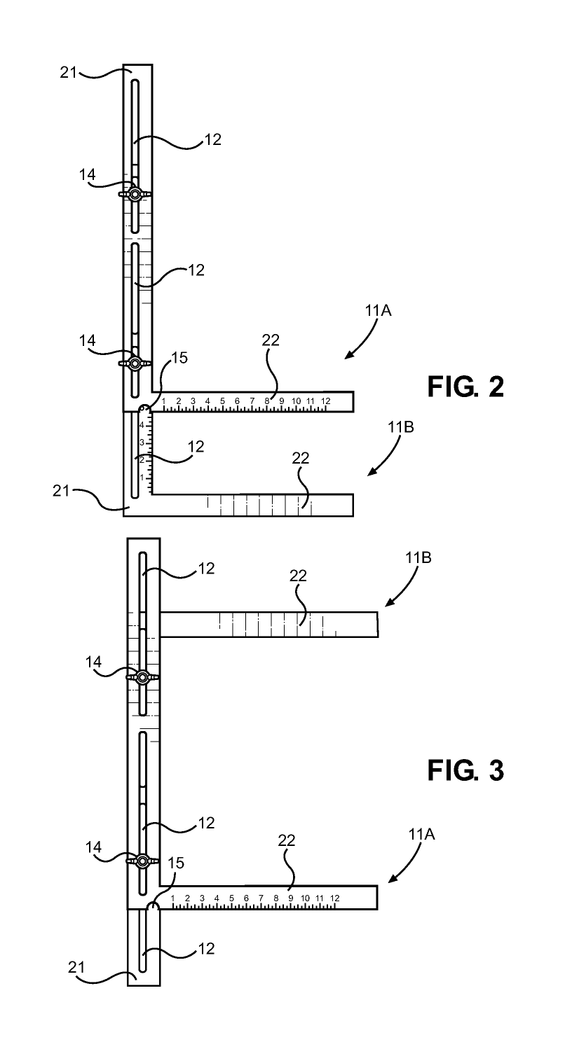

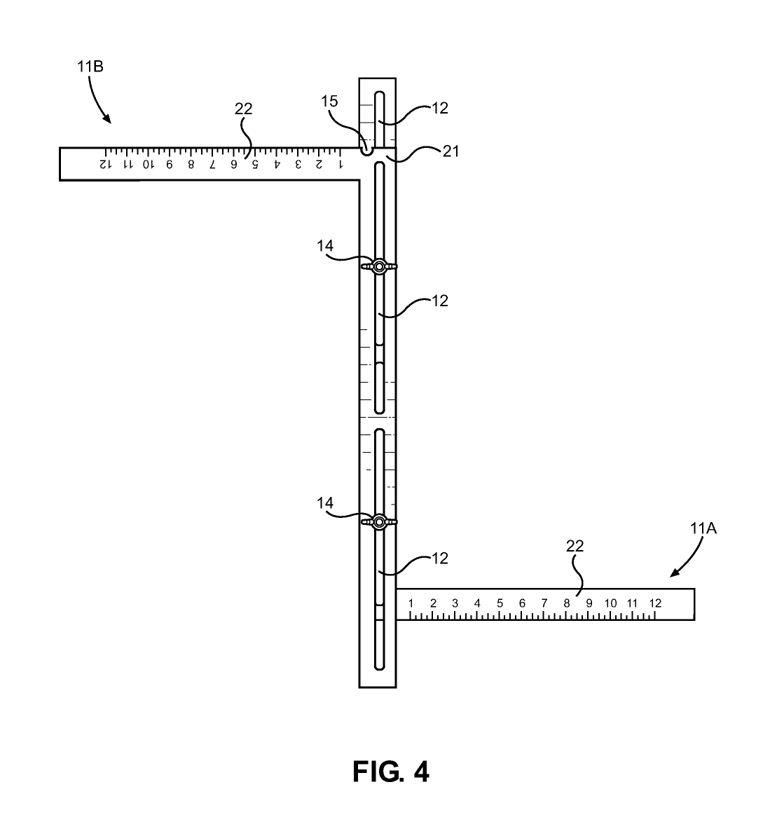

Referring now to FIGS. 3-5, there are shown views of the present invention in a variety of arrangements. The first and second members 11A, 11B can be secured together in a number of different arrangements. As depicted in FIG. 2, the members 11A, 11B can be secured together such that they are in the same orientation but are offset from each other. The length of the slots 12 allows the members 11A, 11B to be offset from each other, while still allowing at least a portion of the complementary slots 12 on the members 11A, 11B to overlie so that a connector 14 can be secured therethrough. This arrangement is ideal for the purpose of transferring parallel lines and other such needs. Alternative to the arrangement depicted in FIG. 2, the members 11A, 11B can be flipped relative to the longitudinal axis of the second portion 22. In these arrangements, the present invention can be used as either inside or outside calipers.

The present invention further comprises a notch 15 disposed at the junction between the first portion 21 and the second portion 22 of the members 11A, 11B. The notch 15 allows the numeral indicia 16 of the underlying second member 11B to be exposed when the second portion 22 of the overlying first member 11A is aligned with a measurement. The measurement indicia 16 are positioned so that they are bisected by the marking to which they correspond for ease of reading. Therefore, without the notch 15, the second portion 22 of the overlying first member 11A would cover up the top half of the bisected numerical indicia 16 and thus make it difficult to read the numeral indicia 16. However, the notch 15 ensures that the numerical indicia 16 corresponding to the marking with which the overlying second portion 22 is aligned is exposed and easily visible by the user.

The present invention can be used to calculate unknown angles using trigonometric principles because the length of the legs are known measurements due to the measurement indicia 16 disposed on the members 11A, 11B. Furthermore, the arrangement depicted in FIG. 3 can be utilized as a centering head for objects having a circular cross-section, such as a tank or a pipe. For example, the user can place the arrangement depicted in FIG. 3 against the side of a pipe, level it using a conventional bubble level or other such device, make a measurement, and then flip the present invention to the other side of the pipe and repeat. The user is thereby able to calculate the center line of the pipe. The present invention is extremely useful for carpenters, pipefitters, construction workers, and other such individuals. The present invention provides users with a means to find any desired angle, transfer parallel lines, and calculate the centerline of an object.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A framing square, comprising:
a first L-shaped member having a slot and measurement indicia disposed thereon;
a second L-shaped member having a slot and measurement indicia thereon;
a connector for removably connecting the first L-shaped member and the second L-shaped member together through the slot of the first L-shaped member and the slot of the second L-shaped member.

2. The framing square of claim 1, wherein the connector comprises:
a body adapted to accept the first L-shaped member and the second L-shaped member therethrough;
one or more in turned flanges attached to the body;
a fastener extending through the body;
wherein tightening of the fasteners causes the first L-shaped member and the second L-shaped member to be held between the fastener and the one or more in turned flanges.

3. The framing square of claim 1, wherein the connector comprises a wing nut.

4. The framing square of claim 1, wherein:
the first L-shaped member comprises a first portion having a length and a second portion having a length;
the second L-shaped member comprises a first portion having a length and a second portion having a length;
wherein the length of the first portion of the first L-shaped member is less than the length of the first portion of the second L-shaped member;
wherein the length of the second portion of the first L-shaped member is less than the length of the second portion of the second L-shaped member.

5. The framing square of claim 1, wherein:
the slot of the first L-shaped member comprises a first slot and a second slot;
the slot of the second L-shaped member comprises a first slot and a second slot.
